(19) United States
(12) Patent Application Publication
(10) Pub. No.: US 2016/0087698 A1
(43) Pub. Date: Mar. 24, 2016

(54) IN-BAND FULL DUPLEX TRANSCEIVER AND IN-BAND FULL DUPLEX MULTI-INPUT MULTI-OUTPUT TRANSCEIVER

(71) Applicant: Electronics and Telecommunications Research Institute, Daejeon (KR)

(72) Inventors: Kapseok CHANG, Daejeon (KR); Seon-Ae KIM, Daejeon (KR); Hyung Sik JU, Daejeon (KR)

(21) Appl. No.: 14/856,787

(22) Filed: Sep. 17, 2015

(30) Foreign Application Priority Data
Sep. 18, 2014 (KR) 10-2014-0124595
Sep. 23, 2014 (KR) 10-2014-0127142
Nov. 17, 2014 (KR) 10-2014-0160311
Sep. 3, 2015 (KR) 10-2015-0125001

(51) Int. Cl. H04B 7/04; H04L 5/14

(52) U.S. Cl. CPC H04B 7/0413; H04L 5/14

(57) ABSTRACT

An in-band full duplex transceiver is provided. The in-band full duplex transceiver includes a distributor and a Finite Impulse Response (FIR) filter. The distributor may include a receiving output terminal that distributes a transmitting signal and a received signal and that outputs the received signal, and a first output terminal that outputs a first signal, which is a signal corresponding to the transmitting signal. The FIR filter may receive an input of a first signal and remove a self-transmitting interference signal that is included in a signal that is output from the receiving output terminal.

### CROSS-REFERENCE TO RELATED APPLICATION

This application claims priority to and the benefit of Korean Patent Application No. 10-2014-0124595, 10-2014-0127142, 10-2014-0160311, and 10-2015-0125001 filed in the Korean Intellectual Property Office on Sep. 18, 2014, Sep. 23, 2014, Nov. 17, 2014, and Sep. 3, 2015, the entire contents of which are incorporated herein by reference.

### BACKGROUND OF THE INVENTION

(a) Field of the Invention

The present invention relates to an in-band full duplex transceiver and an in-band full duplex Multi-Input Multi-Output (MIMO) transceiver.

(b) Description of the Related Art

Nowadays, wireless communication systems generally adapt a half duplex method. Because the half duplex method distributes and transmits or receives a time or a frequency, when transmitting/receiving, orthogonality may be maintained. However, there is a problem that such a half duplex method wastes a resource (time or frequency) and that it is difficult to perform multi-hop relay between small moving cells, and in order to solve a hidden node problem, separate overhead is required.

An in-band full duplex method is suggested as a solution for solving inefficiency of a half duplex method. The in-band full duplex method is technology that can simultaneously transmit/receive in the same band. The in-band full duplex method can theoretically increase a link capacity by up to twice and perform multi-hop relay between small moving cells without waste of a resource. Because the in-band full duplex method can transmit while receiving, separate overhead for solving a hidden mode problem is not required. Therefore, the in-band full duplex method is essential technology in achieving a traffic capacity of 1000 times required in 5G mobile communication.

However, in an in-band full duplex method, a self-transmitting signal flows into a receiver and thus there is a drawback that the self-transmitting signal operates as a self-interference signal that is much stronger than an effective received signal. For Self-Interference Cancellation (SIC), there is antenna area SIC technology that physically considerably separates a transmitting antenna and a receiving antenna. Technology that lowers a self-interference level through antenna area SIC technology and that cancels self-interference that remains in a digital area is referred to as Interference Cancellation System (ICS) technology. A problem of ICS technology is that it cannot be applied to a small apparatus due to physical separation between transmitting and receiving antennas.

In the in-band full duplex method, as technology for SIC, an Electrical Balance Duplex (EBD) method exists. In the EBD, a separate balance network for SIC is installed, and an analog transmitting signal, having passed through a Power Amplifier (PA), is branched to an antenna terminal and a balance network terminal. The balance network performs a function of equally controlling impedance flowing to the antenna terminal and impedance flowing to the balance network terminal. The balance network prevents a transmitting signal from flowing into a receiving terminal through such a function. In a receiving operation, a received signal that flows into the antenna terminal through a function of the balance network flows to the front end of a PA terminal and a Low Noise Amplifier (LNA). Such EBD technology may implement a transmitting/receiving function of an in-band full duplex method using one transmitting/receiving sharing antenna. A merit of EBD technology is to have a simple structure using a balance network, and because the EBD may be formed in an Integrated Circuit (IC) chip, the EBD can be formed smaller and can be designed with low power. However, because EDB technology uses only an impedance matching concept, when a system bandwidth is a wideband, EDB technology cannot entirely satisfy frequency characteristics within the band and thus a drawback of EDB technology is that SIC performance is deteriorated or unstable. Further, EBD technology cannot be extended to Multi-Input Multi-Output (MIMO). That is, in the MIMO, it is difficult to cancel strong interference that flows from another antenna with the balance network.

In an in-band full duplex method, when performing Analog-to-Digital Conversion (ADC) through Automatic Gain Control (AGC), a very large quantization error occurs, compared with a half duplex method. In the in-band full duplex method, because a self-transmitting interference signal that is much larger than a self-received signal flows into a received signal that flows into a receiving terminal, for the sum of the self-received signal and the self-transmitting interference signal, the AGC and the ADC are performed. Thereby, because the in-band full duplex method may have a very high quantization error, it is difficult to apply a high-dimensional modulation method (e.g., M-Quadrature Amplitude Modulation (M-QAM)) to the in-band full duplex method.

### SUMMARY OF THE INVENTION

The present invention has been made in an effort to provide an in-band full duplex transceiver and in-band full duplex MIMO transceiver having advantages of being capable of being applied to a wideband and being capable of reducing a quantization error.

An exemplary embodiment of the present invention provides an in-band full duplex transceiver. The in-band full duplex transceiver includes: a transmitter that generates a transmitting signal; a distributor that distributes the transmitting signal to an antenna and that distributes a received signal that is received through the antenna to a receiver through a receiving output terminal; and a Finite Impulse Response (FIR) filter that receives an input of the transmitting signal and that removes a self-transmitting interference signal that is included in a signal that is output from the receiving output terminal.

The FIR filter may include: a plurality of delay units that each receive and delay an input of the transmitting signal; a plurality of attenuators that are connected to the plurality of delay units, respectively, and that attenuate a signal; and a controller that sets an attenuation level of the plurality of attenuators so as to remove the self-transmitting interference signal.

The controller may set the attenuation level that minimizes the self-transmitting interference signal using a signal that converts the self-transmitting interference signal to a frequency domain and a signal that converts the transmitting signal to a frequency domain.

The receiving output terminal may include a first receiving output terminal and a second receiving output terminal, and a first signal that is output from the first receiving output terminal and a second signal that is output from the second receiving output terminal may be signals having an inverted phase.

The in-band full duplex transceiver may further include: a first coupler that couples the first signal and the second signal; and a second coupler that couples an output of the first coupler and an output of the FIR filter to output the coupled output to the receiver, wherein the FIR filter may output a signal that removes a self-transmitting interference signal that is included in an output signal of the first coupler to the second coupler.

The FIR filter may include a first FIR filter that receives an input of the transmitting signal to remove a self-transmitting interference signal that is included in the first signal and a second FIR filter that receives an input of the transmitting signal to remove a self-transmitting interference signal that is included in the second signal, and the in-band full duplex transceiver may further include: a first coupler that couples the first signal and an output of the first FIR filter to output the coupled signal and output to the receiver; and a second coupler that couples an output of the second signal and the second FIR filter to output the coupled signal and output to the receiver.

The distributor may include a first output terminal that outputs a signal corresponding to the transmitting signal, and the in-band full duplex transceiver may further include: a first coupler that couples the first signal and the second signal; a second coupler that couples an output of the first coupler and an output of the first output terminal; and a third coupler that couples an output of the second coupler and an output of the FIR filter to output the coupled output to the receiver, wherein the FIR filter may output a signal that removes a self-transmitting interference signal that is included in an output signal of the second coupler to the third coupler.

The distributor may include a first output terminal that outputs a signal corresponding to the transmitting signal, the in-band full duplex transceiver may further include a first coupler that couples the first signal and an output of the first output terminal and a second coupler that couples the second signal and an output of the first output terminal, the FIR filter may include a first FIR filter that receives an input of the transmitting signal to remove a self-transmitting interference signal that is included in an output signal of the first coupler and a second FIR filter that receives an input of the transmitting signal to remove a self-transmitting interference signal that is included in an output signal of the second coupler, and the in-band full duplex transceiver may further include a third coupler that couples an output signal of the first coupler and an output signal of the first FIR filter and a fourth coupler that couples an output signal of the second coupler and an output signal of the second FIR filter.

Another embodiment of the present invention provides an in-band full duplex transceiver. The in-band full duplex transceiver includes: a distributor including a receiving output terminal that distributes a transmitting signal to an antenna, that distributes a received signal that is received through the antenna to a receiver, and that outputs the received signal, and a first output terminal that outputs a first signal, which is a signal corresponding to the transmitting signal; and a Finite Impulse Response (FIR) filter that receives an input of the first signal to remove a self-transmitting interference signal that is included in a signal that is output from the receiving output terminal.

The distributor may include: a hybrid transformer that distributes the transmitting signal and that distributes the received signal; and a balance network that is connected to the hybrid transformer and that controls impedance to correspond to impedance flowing to the antenna, wherein the first signal may be a signal that is output to a contact point of the hybrid transformer and the balance network.

The first signal may correspond to a signal that is output from a power amplifier, or may correspond to a signal that is transmitted through the antenna.

The receiving output terminal may include a first receiving output terminal and a second receiving output terminal, and a second signal that is output from the first receiving output terminal and a third signal that is output from the second receiving output terminal may be signals having an inverted phase.

The in-band full duplex transceiver may further include: a first coupler that couples the second signal and the third signal; and a second coupler that couples an output of the first coupler and an output of the FIR filter to output the coupled output to the receiver, wherein the FIR filter may output a signal that removes a self-transmitting interference signal that is included in an output signal of the first coupler to the second coupler.

The FIR filter may include a first FIR filter that receives an input of the first signal to remove a self-transmitting interference signal that is included in the second signal and a second FIR filter that receives an input of the first signal to remove a self-transmitting interference signal that is included in the third signal, and the in-band full duplex transceiver may further include: a first coupler that couples the second signal and an output of the first FIR filter to output the coupled signal and output to the receiver; and a second coupler that couples the third signal and an output of the second FIR filter to output the coupled signal and output to the receiver.

Yet another embodiment of the present invention provides an in-band full duplex Multi-Input Multi-Output (MIMO) transceiver. The in-band full duplex MIMO transceiver includes: a first in-band full duplex transceiver including a first distributor including a first receiving output terminal that distributes a first transmitting signal to a first antenna and that distributes a first received signal that is received through the first antenna to a first receiver and that outputs the first received signal and a first output terminal that outputs a first signal, which is a signal corresponding to the first transmitting signal, and a first Finite Impulse Response (FIR) filter that receives an input of the first signal to remove an interference signal that is included in a signal that is output from the first receiving output terminal; and a second in-band full duplex transceiver including a second distributor including a second output terminal that distributes a second transmitting signal to a second antenna and that distributes a second received signal that is received through the second antenna to a second receiver and that outputs a second signal, which is a signal corresponding to the second transmitting signal, wherein the first in-band full duplex transceiver further includes a second FIR filter that receives an input of the second signal to remove the interference signal.

The first receiving output terminal may include a second receiving output terminal and a third receiving output terminal, and a third signal that is output from the second receiving output terminal and a fourth signal that is output from the third receiving output terminal may be signals having an inverted phase.

The first in-band full duplex transceiver may further include: a first coupler that couples the third signal and the fourth signal; and a second coupler that couples an output of the first coupler, an output of the first FIR filter, and an output of the second FIR filter to output the coupled output to the first receiver, wherein the first FIR filter may output a signal that removes a self-transmitting interference signal that is included in an output signal of the first coupler to the second coupler, and the second FIR filter may output a signal that is included in an output signal of the first coupler and that removes a cross-interference signal that is generated by the second transmitting signal to the second coupler.

The first in-band full duplex transceiver may further include: a first coupler that couples the third signal and the fourth signal; a second coupler that couples the first signal and an output of the second FIR filter; and a third coupler that couples an output of the first coupler and an output of the second FIR filter, wherein the first FIR filter may output a signal that removes a self-transmitting interference signal that is included in an output signal of the first coupler to the third coupler, and the second FIR filter may output a signal that removes a cross-interference signal that is included in an output signal of the first coupler and that is generated by the second transmitting signal to the second coupler.

The first FIR filter may include a third FIR filter that receives an input of the first signal to remove a self-transmitting interference signal that is included in the third signal, and a fourth FIR filter that receives an input of the first signal to remove a self-transmitting interference signal that is included in the fourth signal; the second FIR filter may include a fifth FIR filter that receives an input of the second signal and that is included in the third signal and that removes a cross-interference signal that is generated by the second transmitting signal, and a sixth FIR filter that receives an input of the second signal and that is included in the fourth signal and that removes a cross-interference signal that is generated by the second transmitting signal; and the first in-band full duplex transceiver may further include a first coupler that couples an output of the third FIR filter and an output of the fourth FIR filter, and a second coupler that couples an output of the fifth FIR filter and an output of the sixth FIR filter.

The second FIR filter may include a third FIR filter that receives an input of the second signal and that is included in the third signal and that removes a cross-interference signal that is generated by the second transmitting signal, and a fourth FIR filter that receives an input of the second signal and that is included in the fourth signal and that removes a cross-interference signal that is generated by the second transmitting signal; the first in-band full duplex transceiver may further include a first coupler that couples the first signal and an output of the third FIR filter, and a second coupler that couples the first signal and an output of the fourth FIR filter; the first FIR filter may include a fifth FIR filter that receives an input of an output of the first coupler to remove a self-transmitting interference signal that is included in the third signal, and a sixth FIR filter that receives an input of an output of the second coupler to remove a self-transmitting interference signal that is included in the fourth signal; and the first in-band full duplex transceiver may further include a third coupler that couples the third signal and an output of the fifth FIR filter, and a fourth coupler that couples the fourth signal and an output of the sixth FIR filter.

According to an exemplary embodiment of the present invention, by removing a self-transmitting interference signal using a Finite Impulse Response (FIR) filter, a quantization error as well as a wideband can be reduced.

According to another exemplary embodiment of the present invention, by removing a cross-interference signal as well as a self-transmitting interference signal using an FIR filter, an in-band full duplex MIMO transceiver can be extended to MIMO.

### BRIEF DESCRIPTION OF THE DRAWINGS

FIG. 1 is a diagram illustrating an in-band full duplex transceiver according to an exemplary embodiment of the present invention.

FIG. 2 is a diagram illustrating an FIR filter according to an exemplary embodiment of the present invention.

FIG. 3 is a diagram illustrating an in-band full duplex transceiver according to another exemplary embodiment of the present invention.

FIG. 4 is a diagram illustrating an in-band full duplex transceiver according to another exemplary embodiment of the present invention.

FIG. 5 is a diagram illustrating an in-band full duplex transceiver according to another exemplary embodiment of the present invention.

FIG. 6 is a diagram illustrating an in-band full duplex transceiver according to another exemplary embodiment of the present invention.

FIG. 7 is a diagram illustrating an in-band full duplex transceiver according to another exemplary embodiment of the present invention.

FIG. 8 is a diagram illustrating an in-band full duplex MIMO transceiver according to an exemplary embodiment of the present invention.

FIG. 9 is a diagram illustrating an in-band full duplex MIMO transceiver according to another exemplary embodiment of the present invention.

FIG. 10 is a diagram illustrating an in-band full duplex MIMO transceiver according to another exemplary embodiment of the present invention.

FIG. 11 is a diagram illustrating an in-band full duplex MIMO transceiver according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a transceiver may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the terminal, the MT, the AMS, the HR-MS, the SS, the PSS, the AT, and the UE.

Further, a transceiver may indicate a base station (BS), an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, and a high reliability relay station (HR-RS) that performs a BS function, and may include an entire function or a partial function of the ABS, the nodeB, the eNodeB, the AP, the RAS, the BTS, the MMR-BS, the RS, and the HR-RS.

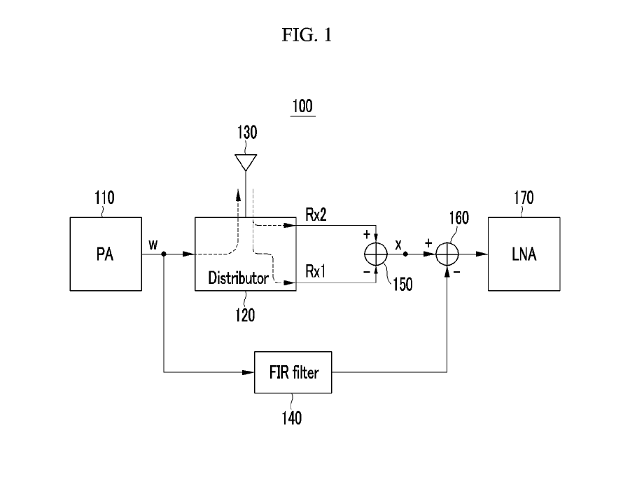

FIG. 1 is a diagram illustrating an in-band full duplex transceiver 100 according to an exemplary embodiment of the present invention.

As shown in FIG. 1, the in-band full duplex transceiver 100 according to an exemplary embodiment of the present invention includes a power amplifier (PA) 110, a distributor 120, an antenna 130, a Finite Impulse Response (FIR) filter 140, a first coupler 150, a second coupler 160, and a low noise amplifier (LNA) 170.

The PA 110 amplifies and outputs a Radio Frequency (RF) signal. In FIG. 1, a transmitting signal that the PA 110 outputs is represented with w. The transmitting signal w is input to the distributor 120 and the FIR filter 140. Such a PA 110 forms a portion of a transmitter.

The distributor 120 is connected to the antenna 130 and sends the transmitting signal w to the antenna 130. The distributor 120 sends a received signal that is received from the antenna 130 to receiving output terminals Rx1 and Rx2. That is, the distributor 120 according to an exemplary embodiment of the present invention performs a function of sending a transmitting signal to the antenna 130 and sending a received signal to a receiver (LNA, etc.). The distributor 120 may be implemented with a circulator. The distributor 120 may be implemented with Electrical Balance Duplex (EBD). The EBD may include a hybrid transformer and a balance network. When the distributor 120 is implemented with an EBD, a phase of a received signal that is received from the antenna 130 is inverted by the hybrid transformer and the received signal is separated, and the separated received signals are each output to the receiving output terminal Rx1 and a receiving output terminal Rx2.

The antenna 130 simultaneously performs a receiving function as well as a transmitting function. A transmitting signal is transmitted and a received signal is received through the antenna 130.

The first coupler 150 couples a received signal that is output from the receiving output terminal Rx1 and the receiving output terminal Rx2. In this case, because the received signal that is output from the receiving output terminal Rx1 and the received signal of the receiving output terminal Rx2 have an opposite phase, the first coupler 150 subtracts the received signal that is output from the receiving output terminal Rx2 from the received signal that is output from the receiving output terminal Rx1 and couples both signals. In FIG. 1, the coupled received signal is represented with x, and the received signal x includes a self-transmitting interference signal of the in-band full duplex transceiver 100 as well as a self-received signal of the in-band full duplex transceiver 100. The transmitting signal w is transmitted to the antenna 130 by the distributor 120, but a portion thereof flows into a receiving terminal (LNA, etc.) to operate as an interference signal, and such an interference signal is a self-transmitting interference signal. In the following description, a self-transmitting interference signal is represented with \tilde{x}. As described in the following description, in an exemplary embodiment of the present invention, such a self-transmitting interference signal \tilde{x} is removed using the FIR filter 140.

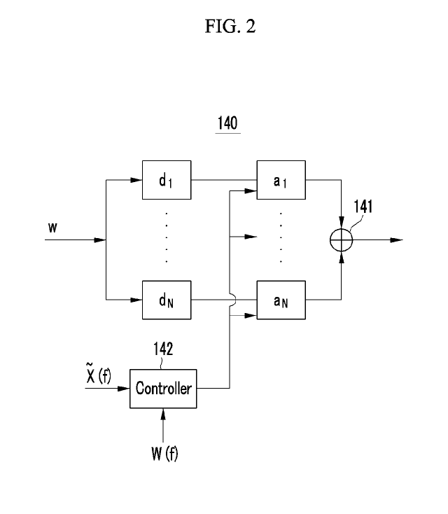

The FIR filter 140 receives an input of a transmitting signal w and generates and outputs a signal that minimizes a self-transmitting interference signal \tilde{x}. A detailed configuration and operation of the FIR filter 140 will be described in detail with reference to FIG. 2.

The second coupler 160 couples a received signal x and an output signal of the FIR filter 140 and outputs the coupled signal to the LNA 170. The second coupler 160 subtracts a signal that is output from the FIR filter 140 from the received signal x and couples both signals. In this case, as described in the following description, because the FIR filter 140 outputs a signal that minimizes a self-transmitting interference signal \tilde{x}, the second coupler 160 outputs a signal that removes the self-transmitting interference signal \tilde{x} from the received signal x to the LNA 170.

The LNA 170 receives an input of a received signal in which the self-transmitting interference signal is removed from the second coupler 160, removes noise from the input signal \tilde{x} and amplifies the signal in which noise is removed. Such an LNA 170 forms a portion of the receiver.

FIG. 2 is a diagram illustrating the FIR filter 140 according to an exemplary embodiment of the present invention.

As shown in FIG. 2, the FIR filter 140 according to an exemplary embodiment of the present invention includes a plurality of delay units d₁-d_{N}, a plurality of attenuators a₁-a_{N}, a coupler 141, and a controller 142.

The plurality of delay units d₁-d_{N} each have fixed delay. Delay gaps between the respective delay units dᵢ (i=1, 2, . . . , N) may be entirely the same or may be entirely different, and the respective delay units dᵢ may be divided into a plurality of groups having the same delay gap.

The plurality of attenuators a₁-a_{N} are connected to the plurality of delay units d₁-d_{N}, respectively, and attenuate a signal. An attenuation level of each attenuator aᵢ (i=1, 2 . . . , N) is variable, and an attenuation level is set by the controller 142.

The controller 142 variably sets an attenuation level of a plurality of attenuators a₁-a_{N}. The controller 142 obtains an attenuation level of a plurality of attenuators a₁-a_{N} using a signal \tilde{X}(f) in which a self-transmitting interference signal \tilde{x} is converted to a frequency domain and a signal W(f) in which a transmitting signal w is converted to a frequency domain. Here, \tilde{X}(f) may be obtained using frequency domain subcarriers that are included in a header of a packet in which a self-received signal is included or peripheral packets thereof, and is well known to a person of ordinary skill in the art and therefore a detailed description thereof will be omitted.

A method in which the controller 142 obtains an attenuation level of a plurality of attenuators a₁-a_{N} will be described as follows.

First, for when delay gaps between respective delay units dᵢ (i=1, 2, . . . , N) may be entirely the same or entirely different, a method in which the FIR filter 140 obtains an attenuation level aᵢ will be described. A method of obtaining aᵢ of the FIR filter 140 is represented by Equation 1.

$${min}_{{a}_{1} , {a}_{2} , … , {a}_{N}} {( \underbrace{\tilde{x} ( t )}_{Self \text{-} Interference} - {\sum }_{i = 1}^{N} {a}_{i} \underbrace{w ( t - {d}_{i} )}_{Tapped signal of reference signal} )}^{2} \qquad ( Equation 1 )$$

In Equation 1, instead of a received signal x, a self-transmitting interference signal \tilde{x} is used. The received signal x of FIG. 1 is a signal in which the self-transmitting interference signal \tilde{x} and the self-received signal are added. Therefore, when using x, in a front terminal of the LNA 170, because a self-received signal as well as a self-transmitting interference signal may be attenuated, in Equation 1, the self-transmitting interference signal \tilde{x} is used. In an analog circuit area, it is not easy to obtain a filter coefficient (i.e., aᵢ) of a time domain of Equation 1. Therefore, by converting Equation 1 to a frequency domain, a filter coefficient may be obtained. A method of obtaining aᵢ of the FIR filter 140 in a frequency domain is represented by Equation 2.

$${min}_{{a}_{1} , {a}_{2} , … , {a}_{N}} {( \underbrace{\tilde{X} ( f )}_{Self \text{-} Interference} - {\sum }_{m = 1}^{N} {a}_{m} W ( f ) {e}^{- j2π {d}_{m} f} )}^{2} \qquad ( Equation 2 )$$

As shown in Equation 2, the controller 142 may obtain an attenuation level of a plurality of attenuators a₁-a_{N} satisfying Equation 2 using a signal \tilde{X}(f) in which a self-transmitting interference signal \tilde{x} is converted to a frequency domain and a signal W(f) in which a transmitting signal w is converted to a frequency domain. In Equation 2, because a portion ( )² has a secondary equation of an attenuation level of a plurality of attenuators a₁-a_{N}, a minimum value of the secondary equation may be obtained. A method of obtaining a₁, a₂, . . . , a_{N} satisfying Equation 2 may be known by a person of ordinary skill in the art and thus a detailed description thereof will be omitted.

Second, in two groups a₁-a_{L} and a_{L+1}-a_{N} in which delay gaps between respective delay units dᵢ (i=1, 2, . . . , N) are the same, a method in which the FIR filter 140 obtains an attenuation level aᵢ will be described. A method of obtaining aᵢ of the FIR filter 140 is represented by Equation 3 in a frequency domain.

$${min}_{{a}_{1} , {a}_{2} , … , {a}_{L}} {( \underbrace{\tilde{X} ( f )}_{Self \text{-} Interference} - {\sum }_{m = 1}^{L} {a}_{m} W ( f ) {e}^{- j2π {d}_{m} f} )}^{2} \\ {min}_{{a}_{L + 1} , {a}_{L + 2} , … , {a}_{N}} {( \underbrace{\tilde{X} ( f )}_{Self \text{-} Interference} - {\sum }_{m = L + 1}^{N} {a}_{m} W ( f ) {e}^{- j2π {d}_{m} f} )}^{2} \qquad ( Equation 3 )$$

In the following description, for convenience of description, an example (when a delay gap is entirely the same or entirely different) of the first delay gap is described, but an example of the second region gap and an example of other delay gaps may be used.

In this way, by applying the FIR filter 140, the in-band full duplex transceiver 100 according to an exemplary embodiment of the present invention can enhance frequency characteristics (i.e., can be applied to a wideband) and solve a quantization error problem in a digital area.

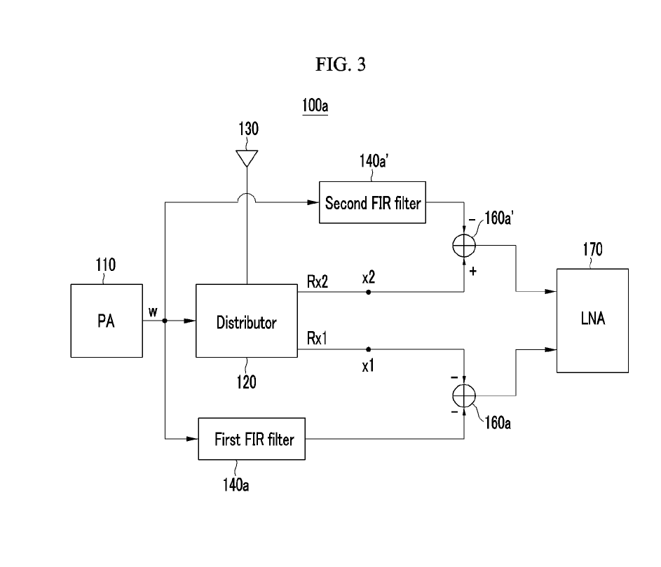

FIG. 3 is a diagram illustrating an in-band full duplex transceiver 100a according to another exemplary embodiment of the present invention.

As shown in FIG. 3, the in-band full duplex transceiver 100a according to another exemplary embodiment of the present invention includes a PA 110, a distributor 120, an antenna 130, a first FIR filter 140a, a second FIR filter 140a′, a first coupler 160a, a second coupler 160a′, and an LNA 170. The in-band full duplex transceiver 100a of FIG. 3 is the same as the in-band full duplex transceiver 100 of FIG. 1 except that two FIR filters are used and that a signal is coupled. Therefore, a detailed description thereof will be omitted.

A transmitting signal w that is output from the PA 110 is input to the distributor 120, the first FIR filter 140a, and the second FIR filter 140a′.

As described in FIG. 1, the distributor 120 inverts a phase of a received signal that is received from the antenna 130 and separates the received signal, and the separated received signals are output to a receiving output terminal Rx1 and a receiving output terminal Rx2. In FIG. 3, a coupled received signal (the sum of a self-received signal and a self-transmitting interference signal) that is output to the receiving output terminal Rx1 is represented with x1, and the coupled received signal (the sum of a self-received signal and a self-transmitting interference signal) that is output to the receiving output terminal Rx2 is represented with x2. x1 and x2 are signals having an inverted phase. In the following description, in x1, a self-transmitting interference signal is represented with [symbol] , and in x2, a self-transmitting interference signal is represented with [symbol] . As described in the following description, the self-transmitting interference signal [symbol] is removed by the first FIR filter 140a, and the self-transmitting interference signal [symbol] is removed by the second FIR filter 140a′.

The first FIR filter 140a receives an input of a transmitting signal w and generates and outputs a signal that minimizes the self-transmitting interference signal [symbol] . The second FIR filter 140a′ receives an input of a transmitting signal w, and generates and outputs a signal that minimizes the self-transmitting interference signal [symbol] . An internal configuration of the first FIR filter 140a and the second FIR filter 140a′ is the same as that of the FIR filter 140 of FIG. 2, and operation thereof is similar to that of the FIR filter 140 of FIG. 2.

The first coupler 160a couples a received signal x1 and an output signal of the first FIR filter 140a and outputs the coupled signal to the LNA 170. The first coupler 160a subtracts a signal that is output from the first FIR filter 140a from an inverted signal (i.e., −x1) of the received signal x1 and couples both signals. Here, the reason why the first coupler 160a inverts the received signal x1 is that the received signal x1 is a received signal having an inverted phase. In this case, because the first FIR filter 140a outputs a signal that minimizes the self-transmitting interference signal [symbol] , as described in the following description, the first coupler 160a outputs a signal in which the self-transmitting interference signal [symbol] is removed from the inverted received signal −x1 to the LNA 170.

The second coupler 160a′ couples a received signal x2 and an output signal of the second FIR filter 140a′ and outputs the coupled signal to the LNA 170. The second coupler 160a′ subtracts a signal that is output from the second FIR filter 140a′ from the received signal x2 and couples both signals. In this case, as described in the following description, because the second FIR filter 140a′ outputs a signal that minimizes the self-transmitting interference signal [symbol] , the second coupler 160a′ outputs a signal in which the self-transmitting interference signal [symbol] is removed from the received signal x2 to the LNA 170.

The LNA 170 receives an input of a received signal in which the self-transmitting interference signal [symbol] is removed from the first coupler 160a, receives an input of a received signal in which a self-transmitting interference signal [symbol] is removed from the second coupler 160a′, removes noise from the input both signals, and amplifies the signal in which noise is removed. Alternatively, the LNA 170 receives an input of a coupled signal of a received signal in which the self-transmitting interference signal [symbol] is removed from the first coupler 160a and a received signal in which the self-transmitting interference signal [symbol] is removed from the second coupler 160a′, removes noise from both input signals, and amplifies the signal in which noise is removed.

A method in which the first FIR filter 140a and the second FIR filter 140a′ obtain an attenuation level of a plurality of attenuators a₁-a_{N} will be described as follows. For when delay gaps between respective delay units dᵢ (i=1, 2, . . . , N) are entirely the same or entirely different, a method in which the first FIR filter 140a and the second FIR filter 140a′ obtain an attenuation level aᵢ will be described. A method of obtaining aᵢ of the first FIR filter 140a and the second FIR filter 140a′ is represented by Equation 4.

$${min}_{{a}_{1} , {a}_{2} , … , {a}_{N}} {( \underbrace{ ( t )}_{Self \text{-} Interference} - {\sum }_{i = 1}^{N} {a}_{i} \underbrace{w ( t - {d}_{i} )}_{Tapped signal of reference signal} )}^{2} \\ {min}_{{a}_{1} , {a}_{2} , … , {a}_{N}} {( \underbrace{ ( t )}_{Self \text{-} Interference} - {\sum }_{i = 1}^{N} {a}_{i} \underbrace{w ( t - {d}_{i} )}_{Tapped signal of reference signal} )}^{2} \qquad ( Equation 4 )$$

In an analog circuit area, it is not easy to obtain a filter coefficient (i.e., aᵢ) of a time domain of Equation 4. Therefore, by converting Equation 4 to a frequency domain, a filter coefficient may be obtained. In a frequency domain, a method of obtaining aᵢ of the first FIR filter 140a and the second FIR filter 140a′ is represented by Equation 5.

$${min}_{{a}_{1} , {a}_{2} , … , {a}_{N}} {( \underbrace{- ( f )}_{Self \text{-} Interference} - {\sum }_{m = 1}^{N} {a}_{m} W ( f ) {e}^{- j2π {d}_{m} f} )}^{2} \\ {min}_{{a}_{1} , {a}_{2} , … , {a}_{N}} {( \underbrace{ ( f )}_{Self \text{-} Interference} - {\sum }_{m = 1}^{N} {a}_{m} W ( f ) {e}^{- j2π {d}_{m} f} )}^{2} \qquad ( Equation 5 )$$

As shown in Equation 5, the first FIR filter 140a may obtain an attenuation level of a plurality of attenuators a₁-a_{N} satisfying Equation 5 using a signal − [symbol] (f) in which a self-transmitting interference signal − [symbol] is converted to a frequency domain and a signal W(f) in which a transmitting signal w is converted to a frequency domain. The second FIR filter 140a′ may obtain an attenuation level of a plurality of attenuators a₁-a_{N} satisfying Equation 5 using a signal [symbol] (f) in which a self-transmitting interference signal [symbol] is converted to a frequency domain and a signal W(f) in which a transmitting signal w is converted to a frequency domain.

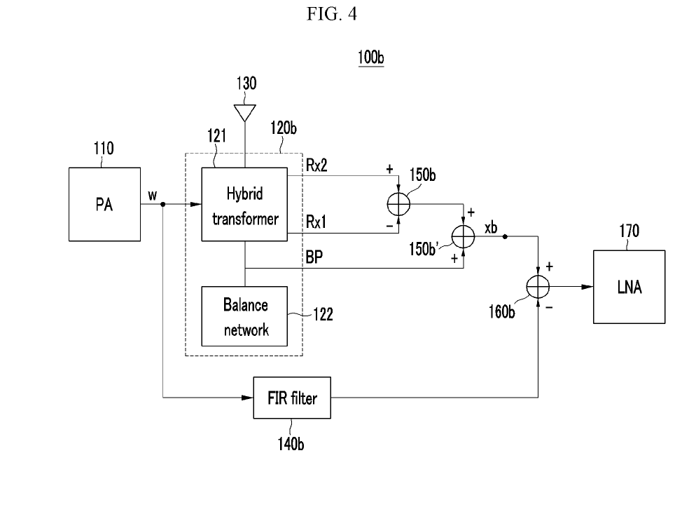

FIG. 4 is a diagram illustrating an in-band full duplex transceiver 100b according to another exemplary embodiment of the present invention.

As shown in FIG. 4, the in-band full duplex transceiver 100b according to another exemplary embodiment of the present invention includes a PA 110, a distributor 120b, an antenna 130, an FIR filter 140b, a first coupler 150b, a second coupler 150b′, a third coupler 160b, and an LNA 170. The in-band full duplex transceiver 100b of FIG. 4 is similar to the in-band full duplex transceiver 100 of FIG. 1 except that the distributor 120b is implemented with an Electrical Balance Duplex (EBD). Therefore, a detailed description thereof will be omitted.

The distributor 120b includes a hybrid transformer 121 and a balance network 122. The hybrid transformer 121 branches a transmitting signal w to the antenna 130 and the balance network 122. At a contact point (hereinafter referred to as a balance point (BP)) of the hybrid transformer 121 and the balance network 122, a signal corresponding to a signal of the rear end of the PA 110 or a transmitting signal of the antenna 130 is output. The balance network 122 is formed with a passive element, and performs a function of equally controlling impedance flowing to the antenna 130 and impedance flowing to the balance network 122. A phase of a received signal that is received from the antenna 130 is inverted by the hybrid transformer 121 and the received signal is thus separated, and the separated received signals are output to a receiving output terminal Rx1 and a receiving output terminal Rx2. The signal that is received from the antenna 130 is output to the BP. Therefore, a portion of a received signal as well as a portion of a transmitting signal are output to the BP. A detailed internal configuration of the hybrid transformer 121 and the balance network 122 may be known by a person of ordinary skill in the art, and thus a detailed description thereof will be omitted.

The first coupler 150b couples a received signal that is output from the receiving output terminal Rx1 and the receiving output terminal Rx2. In this case, because the received signal that is output from the receiving output terminal Rx1 and the received signal of the receiving output terminal Rx2 have opposite phases, the first coupler 150b subtracts the received signal that is output from the receiving output terminal Rx2 from the received signal that is output from the receiving output terminal Rx1 and couples both signals.

The second coupler 150b′ couples a signal that is output from the first coupler 150b and a signal that is output from the BP. In this case, because the signal that is output from the first coupler 150b and the signal that is output from the BP signal have the same phase, the second coupler 150b′ couples both signals. In FIG. 4, a signal that the second coupler 150b′ outputs is represented with xb, and xb includes a self-transmitting interference signal of the in-band full duplex transceiver 100b as well as a self-received signal of the in-band full duplex transceiver 100b. Hereinafter, in xb, a self-transmitting interference signal is represented with [symbol] . As described in the following description, in an exemplary embodiment of the present invention, such a self-transmitting interference signal [symbol] is removed using the FIR filter 140b.

The FIR filter 140b receives an input of a transmitting signal w, and generates and outputs a signal that minimizes the self-transmitting interference signal [symbol] . An internal configuration of the FIR filter 140b is the same as that of the FIR filter 140 of FIG. 2, and operation thereof is similar to that of the FIR filter 140 of FIG. 2.

The third coupler 160b couples an output signal xb of the second coupler 150b′ and an output signal of the FIR filter 140b, and outputs the coupled output signal to the LNA 170. The third coupler 160b subtracts a signal that is output from the FIR filter 140b from xb and couples both signals. In this case, as described in the following description, because the FIR filter 140b outputs a signal that minimizes a self-transmitting interference signal [symbol] , the third coupler 160b outputs a signal that removes the self-transmitting interference signal [symbol] from xb to the LNA 170.

A method in which the FIR filter 140b obtains an attenuation level of a plurality of attenuators a₁-a_{N} will be described as follows. For when delay gaps between respective delay units dᵢ (i=1, 2, . . . , N) are entirely the same or entirely different, a method in which the FIR filter 140b obtains an attenuation level aᵢ will be described. A method of obtaining aᵢ of the FIR filter 140b is represented by Equation 6.

$${min}_{{a}_{1} , {a}_{2} , … , {a}_{N}} {( \underbrace{ ( t )}_{Self \text{-} Interference} - {\sum }_{i = 1}^{N} {a}_{i} \underbrace{w ( t - {d}_{i} )}_{Tapped signal of reference signal} )}^{2} \qquad ( Equation 6 )$$

In an analog circuit area, it is not easy to obtain a filter coefficient (i.e., aᵢ) of a time domain of Equation 6. Therefore, by converting Equation 6 to a frequency domain, a filter coefficient may be obtained. A method of obtaining aᵢ of the FIR filter 140b in a frequency domain is represented by Equation 7.

$${min}_{{a}_{1} , {a}_{2} , … , {a}_{N}} {( \underbrace{ ( f )}_{Self \text{-} Interference} - {\sum }_{m = 1}^{N} {a}_{m} W ( f ) {e}^{- j 2 π {d}_{m} f} )}^{2} \qquad ( Equation 7 )$$

As shown in Equation 7, the FIR filter 140b may obtain an attenuation level of a plurality of attenuators a₁-a_{N} satisfying Equation 7 using a signal [symbol] (f) in which a self-transmitting interference signal [symbol] is converted to a frequency domain and a signal W(f) in which a transmitting signal w is converted to a frequency domain.

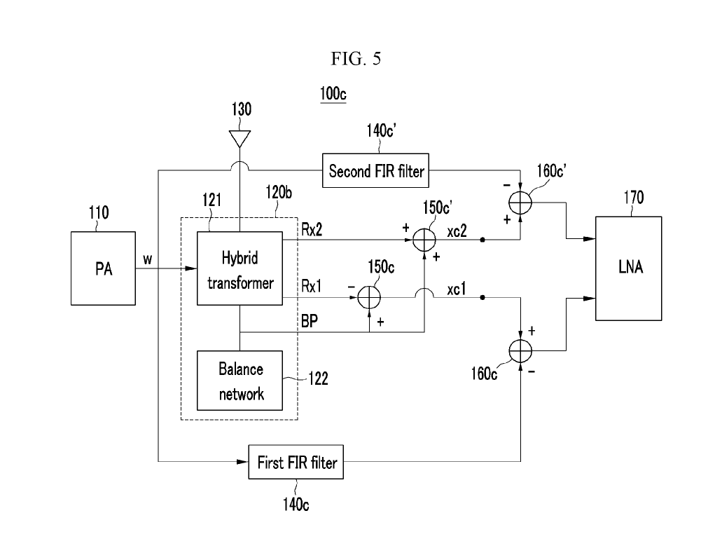

FIG. 5 is a diagram illustrating an in-band full duplex transceiver 100c according to another exemplary embodiment of the present invention.

As shown in FIG. 5, the in-band full duplex transceiver 100c according to another exemplary embodiment of the present invention includes a PA 110, a distributor 120b, an antenna 130, a first FIR filter 140c, a second FIR filter 140c′, a first coupler 150c, a second coupler 150c′, a third coupler 160c, a fourth coupler 160c′, and an LNA 170. The in-band full duplex transceiver 100c of FIG. 5 is similar to the in-band full duplex transceiver 100b of FIG. 4 except that two FIR filters are used and that a signal is coupled. Therefore, a detailed description thereof will be omitted.

A transmitting signal w that is output from the PA 110 is input to the distributor 120b, the first FIR filter 140c, and the second FIR filter 140c′.

As described in FIG. 4, a phase of a received signal that is received from the antenna 130 is inverted by a hybrid transformer 121 and the received signal is thus separated, and the separated received signals are output to a receiving output terminal Rx1 and a receiving output terminal Rx2. The signal that is received from the antenna 130 is output to a BP. Therefore, a portion of a received signal as well as a portion of a transmitting signal are output to the BP.

The first coupler 150c couples a signal that is output from the receiving output terminal Rx1 and a signal that is output from the BP. In this case, because the signal that is output from the receiving output terminal Rx1 and the signal that is output from the BP have opposite phases, the first coupler 150c subtracts the signal that is output from the receiving output terminal Rx1 from the signal that is output from the BP and couples both signals. In FIG. 5, a signal that the first coupler 150c outputs is represented with xc1, and xc1 includes a self-transmitting interference signal of the in-band full duplex transceiver 100c as well as a self-received signal of the in-band full duplex transceiver 100c.

Hereinafter, in xc1, the self-transmitting interference signal is represented with [symbol] . As described in the following description, in an exemplary embodiment of the present invention, such a self-transmitting interference signal [symbol] is removed using the first FIR filter 140c.

The second coupler 150c′ couples a signal that is output from the receiving output terminal Rx2 and a signal that is output from the BP. In this case, because the signal that is output from the receiving output terminal Rx2 and the signal that is output from the BP have the same phase, the second coupler 150c′ couples both signals. In FIG. 5, a signal in which the second coupler 150c′ outputs is represented with xc2, and xc2 includes a self-transmitting interference signal of the in-band full duplex transceiver 100c as well as a self-received signal of the in-band full duplex transceiver 100c. Hereinafter, in xc2, the self-transmitting interference signal is represented with [symbol] . As described in the following description, in an exemplary embodiment of the present invention, such a self-transmitting interference signal [symbol] is removed using the second FIR filter 140c′.

The first FIR filter 140c receives an input of a transmitting signal w, and generates and outputs a signal that minimizes the self-transmitting interference signal [symbol] . The second FIR filter 140c′ receives an input of a transmitting signal w, and generates and outputs a signal that minimizes the self-transmitting interference signal [symbol] . An internal configuration of the first FIR filter 140c and the second FIR filter 140c′ is the same as that of the FIR filter 140 of FIG. 2, and operation thereof is similar to the FIR filter 140 of FIG. 2.

The third coupler 160c couples an output signal xc1 of the first coupler 150c and an output signal of the first FIR filter 140c, and outputs the coupled output signal to the LNA 170. The third coupler 160c subtracts a signal that is output from the first FIR filter 140c from xc1 and couples both signals. In this case, as described in the following description, because the first FIR filter 140c outputs a signal that minimizes the self-transmitting interference signal [symbol] , the third coupler 160c outputs a signal that removes the self-transmitting interference signal [symbol] from xc1 to the LNA 170.

The fourth coupler 160c′ couples an output signal xc2 of the second coupler 150c′ and an output signal of the second FIR filter 140c′, and outputs the coupled output signal to the LNA 170. Alternatively, the LNA 170 receives an input of a coupled signal of a received signal in which a self-transmitting interference signal is removed from the third coupler 160c and a received signal in which a self-transmitting interference signal is removed from the fourth coupler 160c′, removes noise from the input both signals, and amplifies the signal in which noise is removed.

The fourth coupler 160c′ subtracts a signal that is output from the second FIR filter 140c′ from xc2 and couples both signals. In this case, as described in the following description, because the second FIR filter 140c′ outputs a signal that minimizes the self-transmitting interference signal [symbol] , the fourth coupler 160c′ outputs a signal in which the self-transmitting interference signal [symbol] is removed from xc2 to the LNA 170.

A method in which the first FIR filter 140c and the second FIR filter 140c′ obtain an attenuation level of a plurality of attenuators a₁-a_{N} will be described as follows. For when delay gaps between respective delay units dᵢ (i=1, 2, . . . , N) are entirely the same or entirely different, a method in which the first FIR filter 140c and the second FIR filter 140c′ obtains an attenuation level aᵢ will be described. A method of obtaining aᵢ of the first FIR filter 140c and the second FIR filter 140c′ is represented by Equation 8.

$${min}_{{a}_{1} , {a}_{2} , … , {a}_{N}} {( {{⏟}_{Self \text{-} Interference}}_{} - {\sum }_{i = 1}^{N} {a}_{i} \underbrace{w ( t - {d}_{i} )}_{Tapped signal of reference signal} )}^{2} \\ {min}_{{a}_{1} , {a}_{2} , … , {a}_{N}} {( {{⏟}_{Self \text{-} Interference}}_{} - {\sum }_{i = 1}^{N} {a}_{i} \underbrace{w ( t - {d}_{i} )}_{Tapped signal of reference signal} )}^{2} \qquad ( Equation 8 )$$

In an analog circuit area, it is not easy to obtain a filter coefficient (i.e., aᵢ) of a time domain of Equation 8. Therefore, by converting Equation 8 to a frequency domain, a filter coefficient may be obtained. A method of obtaining aᵢ of the first FIR filter 140c and the second FIR filter 140c′ in a frequency domain is represented by Equation 9.

$${min}_{{a}_{1} , {a}_{2} , … , {a}_{N}} {( {{⏟}_{Self \text{-} Interference}}_{} - {\sum }_{m = 1}^{N} {a}_{m} W ( f ) {e}^{- j 2 π {d}_{m} f} )}^{2} \\ {min}_{{a}_{1} , {a}_{2} , … , {a}_{N}} {( {{⏟}_{Self \text{-} Interference}}_{} - {\sum }_{m = 1}^{N} {a}_{m} W ( f ) {e}^{- j 2 π {d}_{m} f} )}^{2} \qquad ( Equation 9 )$$

As shown in Equation 9, the first FIR filter 140c may obtain an attenuation level of a plurality of attenuators a₁-a_{N} satisfying Equation 9 using a signal [symbol] (f) in which a self-transmitting interference signal [symbol] is converted to a frequency domain and a signal W(f) in which a transmitting signal w is converted to a frequency domain. The second FIR filter 140c′ may obtain an attenuation level of a plurality of attenuators a₁-a_{N} satisfying Equation 9 using a signal [symbol] (f) in which a self-transmitting interference signal [symbol] is converted to a frequency domain and a signal W(f) in which a transmitting signal w is converted to a frequency domain.

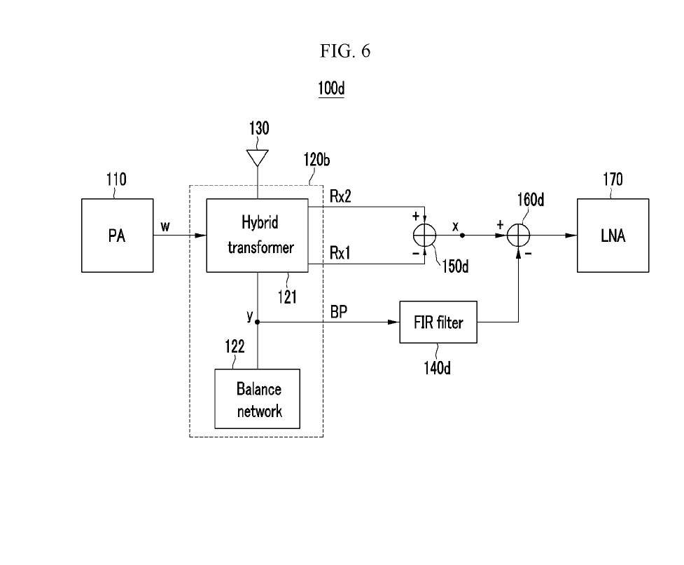

FIG. 6 is a diagram illustrating an in-band full duplex transceiver 100d according to another exemplary embodiment of the present invention.

As shown in FIG. 6, the in-band full duplex transceiver 100d according to another exemplary embodiment of the present invention includes a PA 110, a distributor 120b, an antenna 130, an FIR filter 140d, a first coupler 150d, a second coupler 160d, and an LNA 170. The in-band full duplex transceiver 100d of FIG. 4 is similar to the in-band full duplex transceiver 100 of FIG. 1 except that the distributor 120b is implemented with an Electrical Balance Duplex (EBD). Therefore, a detailed description thereof will be omitted.

As described in FIG. 4, a hybrid transformer 121 branches a transmitting signal w to the antenna 130 and a balance network 122. That is, at a BP, a signal corresponding to a signal of the rear end of the PA 110 or a transmitting signal of the antenna 130 is output. In FIG. 6, a signal that is output to the BP is represented with y. A phase of a received signal that is received from the antenna 130 is inverted by the hybrid transformer 121 and the received signal is thus separated, and the separated received signals are each output to a receiving output terminal Rx1 and a receiving output terminal Rx2.

The first coupler 150d couples received signals that are output from the receiving output terminal Rx1 and the receiving output terminal Rx2. In this case, because the received signal that is output from the receiving output terminal Rx1 and the received signal that is output from the receiving output terminal Rx2 have opposite phases, the first coupler 150d subtracts the received signal that is output from the receiving output terminal Rx2 from the received signal that is output from the receiving output terminal Rx1 and couples both signals. The signal that the first coupler 150d outputs is the same as x of FIG. 1 and is thus represented with x. Such x includes a self-transmitting interference signal of the in-band full duplex transceiver 100d as well as a self-received signal of the in-band full duplex transceiver 100d. Similarly to FIG. 1, in x, a self-transmitting interference signal is represented with \tilde{x}. As described in the following description, in an exemplary embodiment of the present invention, such a self-transmitting interference signal \tilde{x} is removed using the FIR filter 140d.

The FIR filter 140d receives an input of an output signal y of the BP, and generates and outputs a signal that minimizes a self-transmitting interference signal \tilde{x}. An internal configuration of the FIR filter 140d is the same as that of the FIR filter 140 of FIG. 2, and operation thereof is similar to that of the FIR filter 140 of FIG. 2. As described in the foregoing description, a signal corresponding to a transmitting signal w is output to the BP. The FIR filter 140d generates a signal that minimizes a self-transmitting interference signal \tilde{x} using a signal corresponding to a transmitting signal w instead of directly using the transmitting signal w.

The second coupler 160d couples an output signal x of the first coupler 150d and an output signal of the FIR filter 140d and outputs the coupled output signal to the LNA 170. The second coupler 160d subtracts a signal that is output from the FIR filter 140d from x and couples both signals. In this case, as described in the following description, because the FIR filter 140d outputs a signal that minimizes the self-transmitting interference signal \tilde{x}, the second coupler 160d outputs a signal that removes the self-transmitting interference signal \tilde{x} from x to the LNA 170.

A method in which the FIR filter 140d obtains an attenuation level of a plurality of attenuators a₁-a_{N} will be described. For when delay gaps between respective delay units dᵢ (i=1, 2, . . . , N) are entirely the same or entirely different, a method in which the FIR filter 140d obtains an attenuation level aᵢ will be described. A method of obtaining aᵢ of the FIR filter 140d is represented by Equation 10.

$${min}_{{a}_{1} , {a}_{2} , … , {a}_{N}} {( \underbrace{\tilde{x} ( t )}_{Self \text{-} Interference} - {\sum }_{i = 1}^{N} {a}_{i} \underbrace{y ( t - {d}_{i} )}_{Tapped signal of reference signal} )}^{2} \qquad ( Equation 10 )$$

Equation 10 is the same as Equation 1 except that w is replaced with y.

In an analog circuit area, it is not easy to obtain a filter coefficient (i.e., aᵢ) of a time domain of Equation 10. Therefore, by converting Equation 10 to a frequency domain, a filter coefficient may be obtained. A method of obtaining aᵢ of the FIR filter 140d in a frequency domain is represented by Equation 11.

$${min}_{{a}_{1} , {a}_{2} , … , {a}_{N}} {( \underbrace{\tilde{X} ( f )}_{Self \text{-} Interference} - {\sum }_{m = 1}^{N} {a}_{m} Y ( f ) {e}^{- j 2 π {d}_{m} f} )}^{2} \qquad ( Equation 11 )$$

As shown in Equation 11, the FIR filter 140d may obtain an attenuation level of a plurality of attenuators a₁-a_{N} satisfying Equation 11 using a signal \tilde{X}(f) in which a self-transmitting interference signal \tilde{x} is converted to a frequency domain and a signal Y(f) in which an output signal y of the BP is converted to a frequency domain.

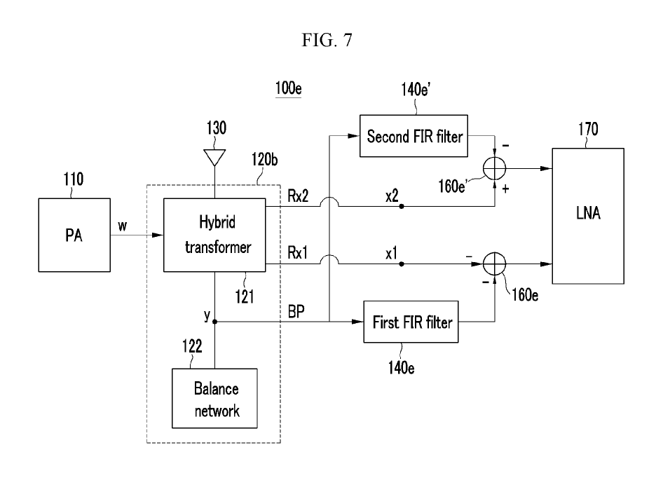

FIG. 7 is a diagram illustrating an in-band full duplex transceiver 100e according to another exemplary embodiment of the present invention.

As shown in FIG. 7, the in-band full duplex transceiver 100e according to another exemplary embodiment of the present invention includes a PA 110, a distributor 120b, an antenna 130, a first FIR filter 140e, a second FIR filter 140e′, a first coupler 160e, a second coupler 160e′, and an LNA 170. The in-band full duplex transceiver 100e of FIG. 7 is the same as the in-band full duplex transceiver 100d of FIG. 6 except that two FIR filters are used and that a signal is coupled. Therefore, a detailed description thereof will be omitted.

In FIG. 7, because a signal that is output from a receiving output terminal Rx1 is the same as x1 of FIG. 3, the signal is represented with x1, and because a signal that is output from a receiving output terminal Rx2 is the same as x2 of FIG. 3, the signal is represented with x2. In the x1, a self-transmitting interference signal is represented with [symbol] , and in the x2, a self-transmitting interference signal is represented with [symbol] . As described in the following description, the self-transmitting interference signal [symbol] is removed by the first FIR filter 140e, and the self-transmitting interference signal [symbol] is removed by the second FIR filter 140e′.

The first FIR filter 140e receives input of an output signal y of a BP, and generates and outputs a signal that minimizes a self-transmitting interference signal [symbol] . The second FIR filter 140e′ receives input of an output signal y of the BP, and generates and outputs a signal that minimizes a self-transmitting interference signal [symbol] .

The first coupler 160e couples an output signal x1 of the receiving output terminal Rx1 and an output signal of the first FIR filter 140e, and outputs the coupled output signal to the LNA 170. The first coupler 160e subtracts a signal that is output from the first FIR filter 140e from an inverted signal (i.e., −x1) of the output signal x1 of the receiving output terminal Rx1 and couples both signals. Here, the reason why the first coupler 160e inverts the output signal x1 of the receiving output terminal Rx1 is that the output signal x1 is a received signal having an inverted phase. In this case, as described in the following description, because the first FIR filter 140e outputs a signal that minimizes the self-transmitting interference signal [symbol] , the first coupler 160e outputs a signal that removes the self-transmitting interference signal [symbol] from the inverted output signal −x1 of the receiving output terminal Rx1 to the LNA 170.

The second coupler 160e′ couples an output signal x2 of the receiving output terminal Rx2 and an output signal of the second FIR filter 140e′ and outputs the coupled output signal to the LNA 170. The second coupler 160e′ subtracts a signal that is output from the first FIR filter 140e from the output signal x1 of the receiving output terminal Rx1 and couples both signals. In this case, as described in the following description, because the second FIR filter 140e′ outputs a signal that minimizes a self-transmitting interference signal [symbol] , the second coupler 160e′ outputs a signal in which the self-transmitting interference signal [symbol] is removed from the output signal x2 of the receiving output terminal Rx2 to the LNA 170. Alternatively, the LNA 170 receives an input of a coupled signal of a received signal in which a self-transmitting interference signal is removed from the first coupler 160e and a received signal in which a self-transmitting interference signal is removed from the second coupler 160e′, removes noise from the input both signals, and amplifies the signal in which noise is removed.

A method in which the first FIR filter 140e and the second FIR filter 140e′ obtain an attenuation level of a plurality of attenuators a₁-a_{N} will be described as follows. For when delay gaps between respective delay units dᵢ (i=1, 2, . . . , N) are entirely the same or entirely different, a method in which the first FIR filter 140e and the second FIR filter 140e′ obtain an attenuation level aᵢ will be described. A method of obtaining aᵢ of the first FIR filter 140e and the second FIR filter 140e′ is represented by Equation 12.

$${min}_{{a}_{1} , {a}_{2} , … , {a}_{N}} {( \underbrace{-}_{Self \text{-} Interference} - {\sum }_{i = 1}^{N} {a}_{i} \underbrace{y ( t - {d}_{i} )}_{Tapped signal of reference signal} )}^{2} \\ {min}_{{a}_{1} , {a}_{2} , … , {a}_{N}} {( \underbrace{-}_{Self \text{-} Interference} - {\sum }_{i = 1}^{N} {a}_{i} \underbrace{y ( t - {d}_{i} )}_{Tapped signal of reference signal} )}^{2} \qquad ( Equation 12 )$$

In an analog circuit area, it is not easy to obtain a filter coefficient (i.e., aᵢ) of a time domain of Equation 12. Therefore, by converting Equation 12 to a frequency domain, a filter coefficient may be obtained. A method of obtaining aᵢ of the first FIR filter 140e and the second FIR filter 140e′ in a frequency domain is represented by Equation 13.

$${min}_{{a}_{1} , {a}_{2} , … , {a}_{N}} {( \underbrace{-}_{Self \text{-} Interference} - {\sum }_{m = 1}^{N} {a}_{m} Y ( f ) {e}^{- j 2 π {d}_{m} f} )}^{2} \\ {min}_{{a}_{1} , {a}_{2} , … , {a}_{N}} {( {{⏟}_{Self \text{-} Interference}}_{} - {\sum }_{m = 1}^{N} {a}_{m} Y ( f ) {e}^{- j 2 π {d}_{m} f} )}^{2} \qquad ( Equation 13 )$$

As shown in Equation 13, the first FIR filter 140e may obtain an attenuation level of a plurality of attenuators a₁-a_{N} satisfying Equation 13 using a signal − [symbol] (f) in which a self-transmitting interference signal − [symbol] is converted to a frequency domain and a signal Y(f) in which an output signal y of the BP is converted to a frequency domain. The second FIR filter 140e′ may obtain an attenuation level of a plurality of attenuators a₁-a_{N} satisfying Equation 13 using a signal [symbol] (f) in which a self-transmitting interference signal [symbol] is converted to a frequency domain and a signal Y(f) in which an output signal y of the BP is converted to a frequency domain.

The in-band full duplex transceiver according to an exemplary embodiment of the present invention that is described with reference to FIGS. 1 to 7 may be applied to a Multi-Input Multi-Output (MIMO) transceiver. Hereinafter, such an in-band full duplex MIMO transceiver will be described. For convenience of description, only 2×2 MIMO is described, but the in-band full duplex MIMO transceiver may be applied to other MIMOs.

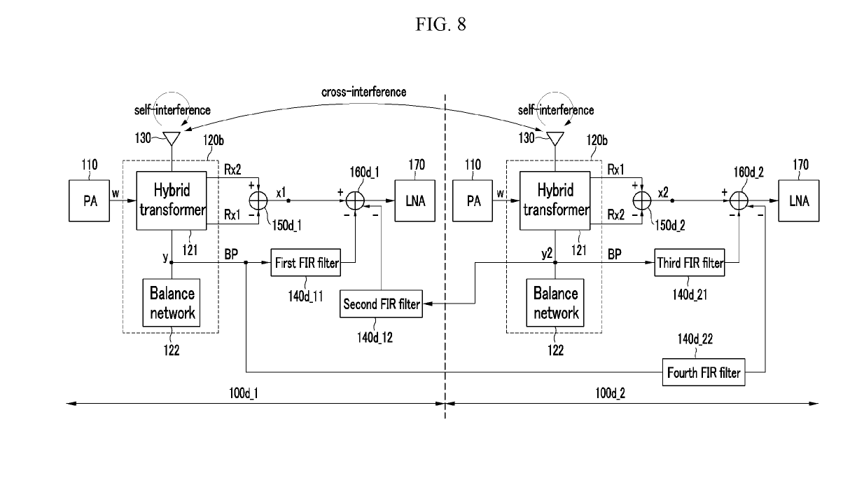

FIG. 8 is a diagram illustrating an in-band full duplex MIMO transceiver according to an exemplary embodiment of the present invention.

As shown in FIG. 8, the in-band full duplex MIMO transceiver according to an exemplary embodiment of the present invention includes a first in-band full duplex transceiver 100d_1 and a second in-band full duplex transceiver 100d_2. The in-band full duplex MIMO transceiver of FIG. 8 is obtained by extending the in-band full duplex transceiver 100d of FIGS. 6 to 2×2 MIMO and thus like reference numerals designate like elements in FIGS. 6 and 8. As shown in FIG. 8, the in-band full duplex MIMO transceiver of FIG. 8 is the same as the in-band full duplex transceiver 100d of FIG. 6 except that four filters are used and therefore a detail description thereof will be omitted.

In the in-band full duplex MIMO transceiver, cross-interference, which is interference of a transmitting and receiving period, as well as self-transmitting interference, occurs. In order to remove such cross-interference, a second FIR filter 140d_12 and a fourth FIR filter 140d_22 are added. x1 and x2 of FIG. 8 correspond to x of FIG. 6, but x1 and x2 include a cross-interference signal as well as a self-received signal and a self-transmitting interference signal. y1 and y2 of FIG. 8 correspond to y of FIG. 6. Hereinafter, in x1, the sum of a self-transmitting interference signal and a cross-interference signal is represented with [symbol] , and in x2, the sum of a self-interference signal and a cross-interference signal is represented with [symbol] . That is, in [symbol] , a cross-interference signal is further included, and in [symbol] , a cross-interference signal is further included.

The second FIR filter 140d_12 receives an input of a signal y2, and generates and outputs a signal that minimizes [symbol] . In order to remove a cross-interference signal, the second FIR filter 140d_12 receives an input of a signal y2. The fourth FIR filter 140d_22 receives an input of a signal y1, and generates and outputs a signal that minimizes [symbol] . In order to remove a cross-interference signal, the fourth FIR filter 140d_22 receives an input of a signal y1. A first FIR filter 140d_11 and a third FIR filter 140d_21 are each the same as the FIR filter 140d of FIG. 6.

A second coupler 160d_1 couples an output signal x1 of a first coupler 150d_1, an output signal of the first FIR filter 140d_11, and an output signal of the second FIR filter 140d_12, and outputs the coupled output signal to the LNA 170. The second coupler 160d_1 subtracts an output signal of the first FIR filter 140d_11 and an output signal of the second FIR filter 140d_12 from x1, and couples three signals. In this case, as described in the following description, because the first FIR filter 140d_11 and the second FIR filter 140d_12 output a signal that minimizes [symbol] , the second coupler 160d_1 outputs a signal that removes [symbol] (self-transmitting interference signal+cross-interference signal) from x1 to the LNA 170.

A fourth coupler 160d_2 couples an output signal x2 of a third coupler 150d_2, an output signal of the third FIR filter 140d_21, and an output signal of the fourth FIR filter 140d_22 and outputs the coupled output signal to the LNA 170. The fourth coupler 160d_2 subtracts an output signal of the third FIR filter 140d_21 and an output signal of the fourth FIR filter 140d_22 from x2 and couples three signals. In this case, as described in the following description, because the third FIR filter 140d_21 and the fourth FIR filter 140d_22 output a signal that minimizes [symbol] , a fourth coupler 160d_2 outputs a signal that removes [symbol] (self-transmitting interference signal+cross-interference signal) from x2 to the LNA 170.

A method in which the first to fourth FIR filters 140d_11-140_22 each obtain an attenuation level of a plurality of attenuators a₁-a_{N} will be described as follows. For when delay gaps between respective delay units dᵢ (i=1, 2, . . . , N) are entirely the same or entirely different, a method in which the first to fourth FIR filters 140d_11-140_22 obtain an attenuation level aᵢ will be described. A method in which the first to fourth FIR filters 140d_11-140_22 obtain aᵢ is represented by Equation 14.

$${min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \qquad ( Equation 14 )$$

Each equation of Equation 14 corresponds to a method of obtaining aᵢ of first to fourth FIR filters 140d_11-140d_22.

In an analog circuit area, it is not easy to obtain a filter coefficient (i.e., aᵢ) of a time domain of Equation 14. Therefore, by converting Equation 14 to a frequency domain, a filter coefficient may be obtained. A method of obtaining aᵢ of the first to fourth FIR filters 140d_11-140_22 is represented by Equation 15.

$${min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \qquad ( Equation 15 )$$

As shown in Equation 15, the first to fourth FIR filters 140d_11-140_22 may each obtain an attenuation level of a plurality of attenuators a₁-a_{N} satisfying Equation 15 using [symbol] (f), [symbol] (f), Y1(f), and Y2(f). Here, [symbol] (f) and [symbol] (f) may be obtained using frequency domain subcarriers that are included in a header of a packet in which a self-received signal is included or peripheral packets thereof, and is well known to a person of ordinary skill in the art and therefore a detailed description thereof will be omitted.

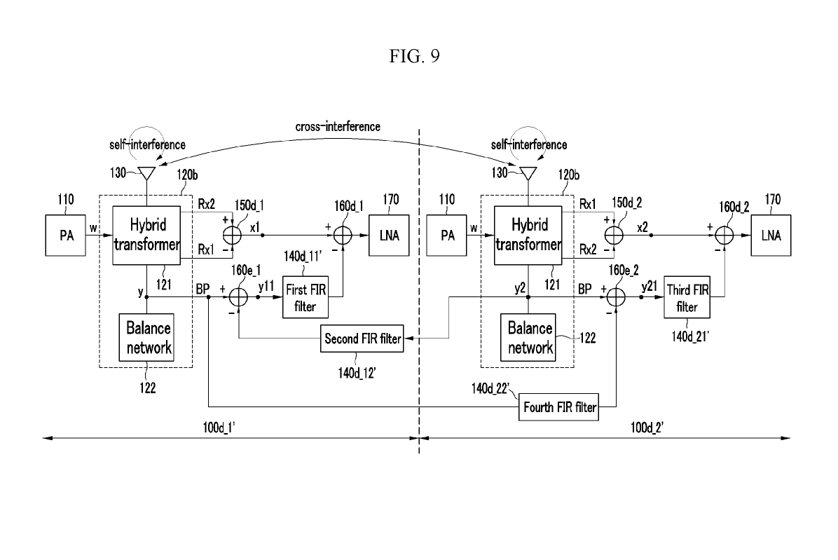

FIG. 9 is a diagram illustrating an in-band full duplex MIMO transceiver according to another exemplary embodiment of the present invention.

As shown in FIG. 9, the in-band full duplex MIMO transceiver according to an exemplary embodiment of the present invention includes a first in-band full duplex transceiver 100d_1′ and a second in-band full duplex transceiver 100d_2′. The in-band full duplex MIMO transceiver of FIG. 9 is another example of extending the in-band full duplex transceiver 100d of FIGS. 6 to 2×2 MIMO. That is, the in-band full duplex MIMO transceiver of FIG. 9 is similar to the in-band full duplex MIMO transceiver of FIG. 8 except that an FIR filter is formed in cascade and thus like reference numerals designate like elements in FIGS. 8 and 9.

A second FIR filter 140d_12′ receives an input of a signal y2, and generates and outputs a signal that minimizes [symbol] . The second FIR filter 140d_12′ receives an input of a signal y2 and performs a function of removing a cross-interference signal in [symbol] . A fourth FIR filter 140d_22′ receives an input of a signal y1, and generates and outputs a signal that minimizes [symbol] . The fourth FIR filter 140d_22′ receives an input of a signal y1 and performs a function of removing a cross-interference signal in [symbol] .

A fifth coupler 160e_1 couples a signal y1 and an output signal of the second FIR filter 140d_12′ and outputs the coupled signal to a first FIR filter 140d_11′. That is, the fifth coupler 160e_1 subtracts an output signal of the second FIR filter 140d_12′ from the signal y1 and couples two signals. In FIG. 9, a signal that the fifth coupler 160e_1 outputs is represented with y11.

The first FIR filter 140d_11′ receives an input of a signal y11 and generates and outputs a signal that minimizes [symbol] . In the signal y11, because both a signal y1 and a signal y2 are included, the first FIR filter 140d_11′ of FIG. 9 performs a function of receiving an input of the signal y11 and finally removing [symbol] .

A sixth coupler 160e_2 couples a signal y2 and an output signal of the fourth FIR filter 140d_22′ and outputs the coupled signal to a third FIR filter 140d_21′. That is, the sixth coupler 160e_2 subtracts an output signal of the fourth FIR filter 140d_22′ from the signal y2 and couples two signals. In FIG. 9, a signal that the sixth coupler 160e_2 outputs is represented with y21.

The third FIR filter 140d_21′ receives an input of a signal y21 and generates and outputs a signal that minimizes [symbol] . In the signal y21, because both a signal y1 and a signal y2 are included, the third FIR filter 140d_21′ of FIG. 9 performs a function of receiving an input of the signal y21 and finally removing [symbol] .

A method in which first to fourth FIR filters 140d_11′-140d_22′ each obtain attenuation level of a plurality of attenuators a₁-a_{N} will be described as follows. For when delay gaps between respective delay units dᵢ (i=1, 2, . . . , N) are entirely the same or entirely different, a method in which the first to fourth FIR filters 140d_11′-140d_22′ obtains an attenuation level aᵢ will be described. A method of obtaining aᵢ of the first to fourth FIR filters 140d_11′-140d_22′ is represented by Equation 16. Each equation of Equation 16 corresponds to a method of obtaining aᵢ of the first to fourth FIR filters 140d_11′-140d_22′.

$${min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 11 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 21 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \qquad ( Equation 16 )$$

Each equation of Equation 16 corresponds to a method of obtaining aᵢ of the first to fourth FIR filters 140d_11′-140d_22′.

In an analog circuit area, it is not easy to obtain a filter coefficient (i.e., aᵢ) of a time domain of Equation 16. Therefore, by converting Equation 16 to a frequency domain, a filter coefficient may be obtained. A method of obtaining aᵢ of the first to fourth FIR filters 140d_11′-140_22′ is represented by Equation 17.

$${min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 11 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 21 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \qquad ( Equation 17 )$$

As shown in Equation 17, the first to fourth FIR filters 140d_11′-140_22′ may obtain an attenuation level of a plurality of attenuators a₁-a_{N} satisfying Equation 17 using [symbol] (f), [symbol] (f), Y1(f), Y2(f), Y11(f), and Y21(f). Here, [symbol] (f) and [symbol] (f) may be obtained using frequency domain subcarriers that are included in a header of a packet in which a self-received signal is included or peripheral packets thereof, and this is well known to a person of ordinary skill in the art and therefore a detailed description thereof will be omitted.

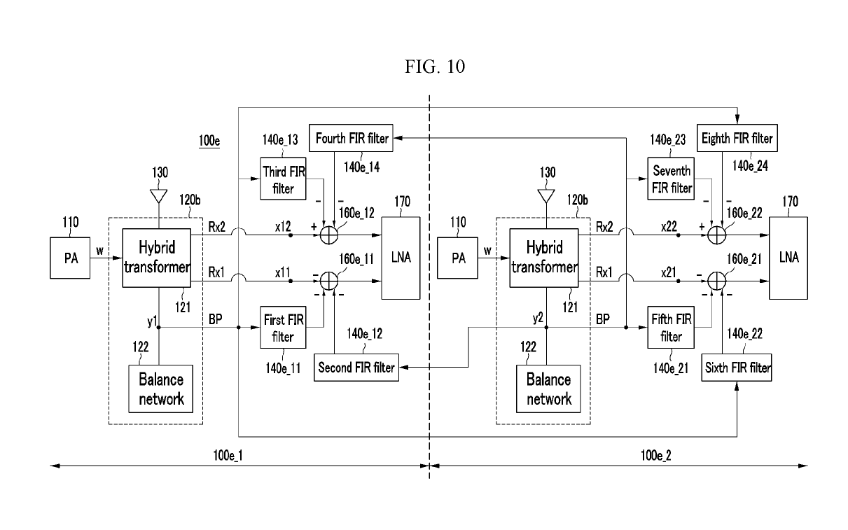

FIG. 10 is a diagram illustrating an in-band full duplex MIMO transceiver according to another exemplary embodiment of the present invention.

As shown in FIG. 10, the in-band full duplex MIMO transceiver according to another exemplary embodiment of the present invention includes a first in-band full duplex transceiver 100e_1 and a second in-band full duplex transceiver 100e_2. The in-band full duplex MIMO transceiver of FIG. 10 is obtained by extending the in-band full duplex transceiver 100e of FIGS. 7 to 2×2 MIMO, and thus like reference numerals designate like elements in FIGS. 7 and 10. As shown in FIG. 10, the in-band full duplex MIMO transceiver of FIG. 10 is the same as the in-band full duplex transceiver 100e of FIG. 7 except that 8 filters are used, and thus a detailed description thereof will be omitted.

In the in-band full duplex MIMO transceiver, cross-interference, which is interference of a transmitting and receiving period, as well as self-transmitting interference, occurs. In order to remove such cross-interference, a second FIR filter 140e_12, a fourth FIR filter 140e_14, a sixth FIR filter 140e_22, and an eighth FIR filter 140e_24 are added. x11 and x12 of FIG. 10 correspond to x1 and x2, respectively, of FIG. 7, and x21 and x22 correspond to x1 and x2 of FIG. 7, respectively. x11-x22 include a cross-interference signal as well as a self-received signal and a self-transmitting interference signal. y1 and y2 of FIG. 9 correspond to y of FIG. 7. Hereinafter, in x11, the sum of a self-transmitting interference signal and a cross-interference signal is represented with [symbol] and in x12, the sum of a self-interference signal and a cross-interference signal is represented with [symbol] . In x21, the sum of a self-transmitting interference signal and a cross-interference signal is represented with [symbol] , and in x22, the sum of a self-interference signal and a cross-interference signal is represented with [symbol] .

The second FIR filter 140e_12 receives an input of a signal y2 and generates and outputs a signal that minimizes [symbol] . That is, the second FIR filter 140e_12 receives an input of a signal y2 and performs a function of removing a cross-interference signal in [symbol] . The fourth FIR filter 140e_14 receives an input of a signal y2 and generates and outputs a signal that minimizes [symbol] . That is, the fourth FIR filter 140e_14 receives an input of a signal y2 and performs a function of removing a cross-interference signal in [symbol] .

A first FIR filter 140e_11 and a third FIR filter 140e_13 perform the same function as that of the first FIR filter 140e and the second FIR filter 140e′ of FIG. 7, and thus a detailed description thereof will be omitted.

A first coupler 160e_11 couples an output signal x11 of a receiving output terminal Rx1, an output signal of the first FIR filter 140e_11, and an output signal of the second FIR filter 140e_12, and outputs the coupled output signal to the LNA 170. The first coupler 160e_11 subtracts an output signal of the first FIR filter 140e_11 and an output signal of the second FIR filter 140e_12 from an inverted signal (i.e., −x11) of the output signal x11 of the receiving output terminal Rx1, and couples three signals. In this case, because the first FIR filter 140e_11 and the second FIR filter 140e_12 output a signal that minimizes [symbol] , as described in the following description, the first coupler 160e_11 outputs a signal that removes [symbol] (self-transmitting interference signal+cross-interference signal) in x11 to the LNA 170.

A second coupler 160e_12 couples an output signal x12 of the receiving output terminal Rx2, an output signal of the third FIR filter 140e_13, and an output signal of the fourth FIR filter 140e_14, and outputs the coupled output signal to the LNA 170. The second coupler 160e_12 subtracts an output signal of the third FIR filter 140e_13 and an output signal of the fourth FIR filter 140e_14 from the output signal x12 of the receiving output terminal Rx2, and couples three signals. In this case, because the third FIR filter 140e_13 and the fourth FIR filter 140e_14 output a signal that minimizes [symbol] , as described in the following description, the second coupler 160e_12 outputs a signal that removes [symbol] (self-transmitting interference signal+cross-interference signal) in x12 to the LNA 170. Alternatively, the LNA 170 receives an input of a coupling signal of a received signal in which a self-transmitting interference signal is removed from the first coupler 160e_11 and a received signal in which a self-transmitting interference signal is removed from the second coupler 160e_12, removes noise from the two input signals, and amplifies the signal in which noise is removed.

The second in-band full duplex transceiver 100e_2 is symmetrical with the first in-band full duplex transceiver 100e_1 and thus a detailed description thereof will be omitted.

A method in which the first to eighth FIR filters 140e_11-140e_24 each obtain an attenuation level of a plurality of attenuators a₁-a_{N} will be described as follows. For when delay gaps between respective delay units dᵢ (i=1, 2, . . . , N) are entirely the same or entirely different, a method in which the first to eighth FIR filters 140e_11-140e_24 obtain an attenuation level aᵢ will be described. A method of obtaining aᵢ of the first to eighth FIR filters 140e_11-140e_24 is represented by Equation 18. Each equation of Equation 18 corresponds to a method of obtaining aᵢ of the first to eighth FIR filters 140e_11-140e_24.

$${min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{i = 1}^{N} {a}_{i} \underbrace{y 1 ( t - {d}_{i} )}_{Tapped signal of reference signal} )}^{2} \\ {min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \qquad ( Equation 18 )$$

Each equation of Equation 18 corresponds to a method of obtaining aᵢ of the first to eighth FIR filters 140e_11-140e_24.

In an analog circuit area, it is not easy to obtain a filter coefficient (i.e., a) of a time domain of Equation 18. Therefore, by converting Equation 18 to a frequency domain, a filter coefficient may be obtained. A method of obtaining aᵢ of the first to eighth FIR filters 140e_11-140e_24 is represented by Equation 19.

$${min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{m = 1}^{N} {a}_{m} Y 1 ( f ) {e}^{- j 2 π {d}_{m} f} )}^{2} \\ {min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \qquad ( Equation 19 )$$

As shown in Equation 19, the first to eighth FIR filters 140e_11-140e_24 may obtain an attenuation level of a plurality of attenuators a₁-a_{N} satisfying Equation 19 using [symbol] (f), [symbol] (f), [symbol] (f), [symbol] (f), [symbol] (f), Y1(f), and Y2(f). Here, [symbol] (f) [symbol] (f), [symbol] (f), [symbol] (f), and [symbol] (f) may be obtained using frequency domain subcarriers that are included in a header of a packet in which a self-received signal is included or peripheral packets thereof, and this is well known to a person of ordinary skill in the art and therefore a detailed description thereof will be omitted.

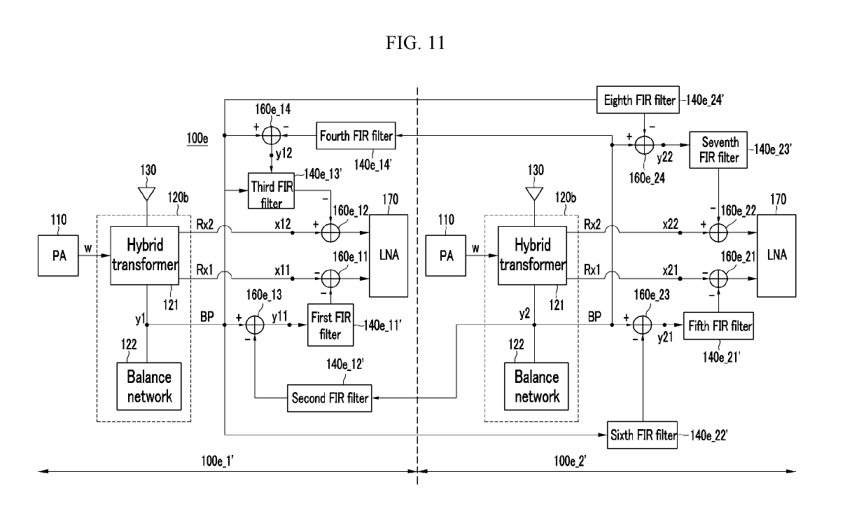

FIG. 11 is a diagram illustrating an in-band full duplex MIMO transceiver according to another exemplary embodiment of the present invention.

As shown in FIG. 11, the in-band full duplex MIMO transceiver according to an exemplary embodiment of the present invention includes a first in-band full duplex transceiver 100e_1′ and a second in-band full duplex transceiver 100e_2′. The in-band full duplex MIMO transceiver of FIG. 11 is another example of extending the in-band full duplex transceiver 100e of FIG. 7 to 2×2 MIMO. That is, the in-band full duplex MIMO transceiver of FIG. 11 is similar to the in-band full duplex MIMO transceiver of FIG. 10 except that an FIR filter is formed in cascade, and thus like reference numerals designate like elements in FIGS. 10 and 11.

A second FIR filter 140e_12′ receives an input of a signal y2, and generates and outputs a signal that minimize [symbol] . The second FIR filter 140e_12′ receives an input of a signal y2 and performs a function of removing a cross-interference signal in [symbol] . A fourth FIR filter 140e_14′ receives an input of a signal y2, and generates and outputs a signal that minimizes [symbol] . That is, the fourth FIR filter 140d_14′ receives an input of a signal y2 to perform a function of removing a cross-interference signal in [symbol] .

A fifth coupler 160e_13 couples a signal y1 and an output signal of the second FIR filter 140e_12′, and outputs the coupled signal to a first FIR filter 140e_11′. That is, the fifth coupler 160e_13 subtracts the output signal of the second FIR filter 140e_12′ from the signal y1 and couples both signals. In FIG. 11, a signal that the fifth coupler 160e_13 outputs was represented with y11.

The first FIR filter 140e_11′ receives an input of a signal y11, and generates and outputs a signal that minimizes [symbol] . In a signal y11, because both a signal y1 and a signal y2 are included, the first FIR filter 140e_11′ of FIG. 11 receives an input of a signal y11 to perform a function of finally removing [symbol] .

A sixth coupler 160e_14 couples a signal y1 and an output signal of the fourth FIR filter 140e_14′ and outputs the coupled signal to a third FIR filter 140e_13′. That is, the sixth coupler 160e_14 subtracts an output signal of the fourth FIR filter 140e_14′ from the signal y1 and couples both signals. In FIG. 11, a signal that the sixth coupler 160e_14 outputs is represented with y12.

The third FIR filter 140d_13′ receives an input of a signal y12 and generates and outputs a signal that minimizes [symbol] . Because the signal y12 includes both a signal y1 and a signal y2, the third FIR filter 140e_13′ of FIG. 11 receives an input of a signal y12 to perform a function of finally removing [symbol] .

The second in-band full duplex transceiver 100e_2′ is symmetrical with the first in-band full duplex transceiver 100e_1′, and thus a detailed description thereof will be omitted.

A method in which the first to eighth FIR filters 140e_11′-140e_24′ each obtain an attenuation level of a plurality of attenuators a₁-a_{N} will be described as follows. For when delay gaps between respective delay units dᵢ (i=1, 2, . . . , N) are entirely the same or entirely different, a method in which the first to eighth FIR filters 140e_11′-140e_24′ obtain an attenuation level aᵢ will be described.

In FIG. 11, a first coupler 160e_11 outputs a signal that removes a self-transmitting interference signal and a cross-interference signal to the LNA 170, and a second coupler 160e_12 outputs a signal that removes a self-transmitting interference signal and a cross-interference signal to the LNA 170. Alternatively, the LNA 170 receives an input of a coupled signal of a received signal in which a self-transmitting interference signal is removed from the first coupler 160e_11 and a received signal in which a self-transmitting interference signal is removed from the second coupler 160e_12, removes noise from the input both signals, and amplifies the signal in which noise is removed.

A method of obtaining aᵢ of the first to eighth FIR filters 140e_11′-140e_24′ is represented by Equation 18. Each equation of Equation 20 corresponds to the method of obtaining aᵢ of the first to eighth FIR filters 140e_11′-140e_24′.

$${min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{i = 1}^{N} {a}_{i} \underbrace{y 11 ( t - {d}_{i} )}_{Tapped signal of reference signal} )}^{2} \\ {min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 12 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 2 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 21 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 22 ( t - {d}_{i} )}_{Tapped signal of reference signal} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{i = 1}^{N} {a}_{i} \underbrace{y 1 ( t - {d}_{i} )}_{Tapped signal of reference signal} )}^{2} \qquad ( Equation 20 )$$

Each equation of Equation 20 corresponds to the method of obtaining aᵢ of the first to eighth FIR filters 140e_11′-140e_24′.

In an analog circuit area, it is not easy to obtain a filter coefficient (i.e., aᵢ) of a time domain of Equation 20. Therefore, by converting Equation 20 to a frequency domain, a filter coefficient may be obtained. A method of obtaining aᵢ of the first to eighth FIR filters 140e_11′-140e_24′ is represented by Equation 21.

$${min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{m = 1}^{N} {a}_{m} Y 11 ( f ) {e}^{- j 2 π {d}_{m} f} )}^{2} \\ {min}_{{a}_{1} , {a}_{2} , … , {a}_{N}} {( \underbrace{-}_{\begin{matrix}Self \text{-} Interference + \\ Cross \text{-} Interference\end{matrix}} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 12 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 2 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 21 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 22 ( f ) {e}^{- j 2 π {d}_{m} f} )}^{2} \\ {min}_{{a}_{1} , {a}_{2} , … , {a}_{N}} {( {{⏟}_{\begin{matrix}Self \text{-} Interference + \\ Cross \text{-} Interference\end{matrix}}}_{} - {\sum }_{m = 1}^{N} {a}_{m} Y 1 ( f ) {e}^{- j 2 π {d}_{m} f} )}^{2} \qquad ( Equation 21 )$$

As shown in Equation 21, the first to eighth FIR filters 140e_11′-140e_24′ may each obtain an attenuation level of a plurality of attenuators a₁-a_{N} satisfying Equation 21 using [symbol] (f), [symbol] (f), [symbol] (f), [symbol] (f), [symbol] (f), Y1(f), and Y2 (f). Here, [symbol] (f), [symbol] (f), [symbol] (f), [symbol] (f), and [symbol] (f) may be obtained using frequency domain subcarriers that are included in a header of a packet in which a self-received signal is included or peripheral packets thereof, and is well known to a person of ordinary skill in the art and therefore a detailed description thereof will be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An in-band full duplex transceiver, comprising:
a transmitter that generates a transmitting signal;
a distributor that distributes the transmitting signal to an antenna and that distributes a received signal that is received through the antenna to a receiver through a receiving output terminal; and
a Finite Impulse Response (FIR) filter that receives an input of the transmitting signal and that removes a self-transmitting interference signal that is included in a signal that is output from the receiving output terminal.

2. The in-band full duplex transceiver of claim 1, wherein the FIR filter comprises:
a plurality of delay units that each receive and delay an input of the transmitting signal;
a plurality of attenuators that are connected to the plurality of delay units, respectively, and that attenuate a signal; and
a controller that sets an attenuation level of the plurality of attenuators so as to remove the self-transmitting interference signal.

3. The in-band full duplex transceiver of claim 2, wherein the controller sets the attenuation level that minimizes the self-transmitting interference signal using a signal that converts the self-transmitting interference signal to a frequency domain and a signal that converts the transmitting signal to a frequency domain.

4. The in-band full duplex transceiver of claim 1, wherein the receiving output terminal comprises a first receiving output terminal and a second receiving output terminal, and
a first signal that is output from the first receiving output terminal and a second signal that is output from the second receiving output terminal are signals having an inverted phase.

5. The in-band full duplex transceiver of claim 4, further comprising:
a first coupler that couples the first signal and the second signal; and
a second coupler that couples an output of the first coupler and an output of the FIR filter to output the coupled output to the receiver,
wherein the FIR filter outputs a signal that removes a self-transmitting interference signal that is included in an output signal of the first coupler to the second coupler.

6. The in-band full duplex transceiver of claim 4, wherein the FIR filter comprises a first FIR filter that receives an input of the transmitting signal to remove a self-transmitting interference signal that is included in the first signal and a second FIR filter that receives an input of the transmitting signal to remove a self-transmitting interference signal that is included in the second signal, and
the in-band full duplex transceiver further comprises:
a first coupler that couples the first signal and an output of the first FIR filter to output the coupled signal and output to the receiver; and
a second coupler that couples the second signal and an output of the second FIR filter to output the coupled signal and output to the receiver.

7. The in-band full duplex transceiver of claim 4, wherein the distributor comprises
a first output terminal that outputs a signal corresponding to the transmitting signal, and
the in-band full duplex transceiver further comprises:
a first coupler that couples the first signal and the second signal;
a second coupler that couples an output of the first coupler and an output of the first output terminal; and
a third coupler that couples an output of the second coupler and an output of the FIR filter to output the coupled output to the receiver,
wherein the FIR filter outputs a signal that removes a self-transmitting interference signal that is included in an output signal of the second coupler to the third coupler.

8. The in-band full duplex transceiver of claim 4, wherein the distributor comprises a first output terminal that outputs a signal corresponding to the transmitting signal,
the in-band full duplex transceiver further comprises a first coupler that couples the first signal and an output of the first output terminal and a second coupler that couples the second signal and an output of the first output terminal,
the FIR filter comprises a first FIR filter that receives an input of the transmitting signal to remove a self-transmitting interference signal that is included in an output signal of the first coupler and a second FIR filter that receives an input of the transmitting signal to remove a self-transmitting interference signal that is included in an output signal of the second coupler, and
the in-band full duplex transceiver further comprises a third coupler that couples an output signal of the first coupler and an output signal of the first FIR filter and a fourth coupler that couples an output signal of the second coupler and an output signal of the second FIR filter.

9. An in-band full duplex transceiver, comprising:
a distributor comprising a receiving output terminal that distributes a transmitting signal to an antenna, that distributes a received signal that is received through the antenna to a receiver, and that outputs the received signal, and a first output terminal that outputs a first signal, which is a signal corresponding to the transmitting signal; and
a Finite Impulse Response (FIR) filter that receives an input of the first signal to remove a self-transmitting interference signal that is included in a signal that is output from the receiving output terminal.

10. The in-band full duplex transceiver of claim 8, wherein the distributor comprises:
a hybrid transformer that distributes the transmitting signal and that distributes the received signal; and
a balance network that is connected to the hybrid transformer and that controls impedance to correspond to impedance flowing to the antenna,
wherein the first signal is a signal that is output to a contact point of the hybrid transformer and the balance network.

11. The in-band full duplex transceiver of claim 9, wherein the first signal corresponds to a signal that is output from a power amplifier or corresponds to a signal that is transmitted through the antenna.

12. The in-band full duplex transceiver of claim 9, wherein the receiving output terminal comprises a first receiving output terminal and a second receiving output terminal, and
a second signal that is output from the first receiving output terminal and a third signal that is output from the second receiving output terminal are signals having an inverted phase.

13. The in-band full duplex transceiver of claim 12, further comprising:
a first coupler that couples the second signal and the third signal; and
a second coupler that couples an output of the first coupler and an output of the FIR filter to output the coupled output to the receiver,
wherein the FIR filter outputs a signal that removes a self-transmitting interference signal that is included in an output signal of the first coupler to the second coupler.

14. The in-band full duplex transceiver of claim 12, wherein the FIR filter comprises
a first FIR filter that receives an input of the first signal to remove a self-transmitting interference signal that is included in the second signal and a second FIR filter that receives an input of the first signal to remove a self-transmitting interference signal that is included in the third signal, and
the in-band full duplex transceiver further comprises:
a first coupler that couples the second signal and an output of the first FIR filter to output the coupled signal and output to the receiver; and
a second coupler that couples the third signal and an output of the second FIR filter to output the coupled signal and output to the receiver.

15. An in-band full duplex Multi-Input Multi-Output (MIMO) transceiver, comprising:
a first in-band full duplex transceiver comprising a first distributor comprising a first receiving output terminal that distributes a first transmitting signal to a first antenna and that distributes a first received signal that is received through the first antenna to a first receiver and that outputs the first received signal and a first output terminal that outputs a first signal, which is a signal corresponding to the first transmitting signal, and a first Finite Impulse Response (FIR) filter that receives an input of the first signal to remove an interference signal that is included in a signal that is output from the first receiving output terminal; and
a second in-band full duplex transceiver comprising a second distributor comprising a second output terminal that distributes a second transmitting signal to a second antenna and that distributes a second received signal that is received through the second antenna to a second receiver and that outputs a second signal, which is a signal corresponding to the second transmitting signal,
wherein the first in-band full duplex transceiver further comprises a second FIR filter that receives an input of the second signal to remove the interference signal.

16. The in-band full duplex MIMO transceiver of claim 15, wherein the first receiving output terminal comprises a second receiving output terminal and a third receiving output terminal, and
a third signal that is output from the second receiving output terminal and a fourth signal that is output from the third receiving output terminal are signals having an inverted phase.

17. The in-band full duplex MIMO transceiver of claim 16, wherein the first in-band full duplex transceiver further comprises:
a first coupler that couples the third signal and the fourth signal; and
a second coupler that couples an output of the first coupler, an output of the first FIR filter, and an output of the second FIR filter to output the coupled output to the first receiver,
wherein the first FIR filter outputs a signal that removes a self-transmitting interference signal that is included in an output signal of the first coupler to the second coupler, and
the second FIR filter outputs a signal that is included in an output signal of the first coupler and that removes a cross-interference signal that is generated by the second transmitting signal to the second coupler.

18. The in-band full duplex MIMO transceiver of claim 16, wherein the first in-band full duplex transceiver further comprises:
a first coupler that couples the third signal and the fourth signal;
a second coupler that couples the first signal and an output of the second FIR filter; and
a third coupler that couples an output of the first coupler and an output of the second FIR filter,
wherein the first FIR filter outputs a signal that removes a self-transmitting interference signal that is included in an output signal of the first coupler to the third coupler, and
the second FIR filter outputs a signal that removes a cross-interference signal that is included in an output signal of the first coupler and that is generated by the second transmitting signal to the second coupler.

19. The in-band full duplex MIMO transceiver of claim 16, wherein the first FIR filter comprises a third FIR filter that receives an input of the first signal to remove a self-transmitting interference signal that is included in the third signal, and a fourth FIR filter that receives an input of the first signal to remove a self-transmitting interference signal that is included in the fourth signal;
the second FIR filter comprises a fifth FIR filter that receives an input of a the second signal and that is included in the third signal and that removes a cross-interference signal that is generated by the second transmitting signal, and a sixth FIR filter that receives an input of the second signal and that is included in the fourth signal and that removes a cross-interference signal that is generated by the second transmitting signal; and
the first in-band full duplex transceiver further comprises a first coupler that couples an output of the third FIR filter and an output of the fourth FIR filter; and a second coupler that couples an output of the fifth FIR filter and an output of the sixth FIR filter.

20. The in-band full duplex MIMO transceiver of claim 16, wherein the second FIR filter comprises a third FIR filter that receives an input of the second signal and that is included in the third signal and that removes a cross-interference signal that is generated by the second transmitting signal, and a fourth FIR filter that receives an input of the second signal and that is included in the fourth signal and that removes a cross-interference signal that is generated by the second transmitting signal;
the first in-band full duplex transceiver further comprises a first coupler that couples the first signal and an output of the third FIR filter, and a second coupler that couples the first signal and an output of the fourth FIR filter;
the first FIR filter comprises a fifth FIR filter that receives an input of an output of the first coupler to remove a self-transmitting interference signal that is included in the third signal, and a sixth FIR filter that receives an input of an output of the second coupler to remove a self-transmitting interference signal that is included in the fourth signal; and
the first in-band full duplex transceiver further comprises a third coupler that couples the third signal and an output of the fifth FIR filter, and a fourth coupler that couples the fourth signal and an output of the sixth FIR filter.
